(19) United States
(12) Patent Application Publication
(10) Pub. No.: US 2008/0205545 A1
(43) Pub. Date: Aug. 28, 2008

(54) Method and System for Using a Phase Locked Loop for Upconversion in a Wideband Crystalless Polar Transmitter

(76) Inventor: Ahmadreza Rofougaran, Newport Coast, CA (US)

Correspondence Address: MCANDREWS HELD & MALLOY, LTD, 500 WEST MADISON STREET, SUITE 3400, CHICAGO, IL, 60661, US

(21) Appl. No.: 11/680,188

(22) Filed: Feb. 28, 2007

(51) Int. Cl. H04L 27/00

(52) U.S. Cl. 375/295; 375/E01.002

(57) ABSTRACT

Certain aspects of a method and system for using a phase locked loop (PLL) as a filter in a wideband crystalless polar transmitter may be disclosed. Exemplary aspects of the method may include modifying a clock signal generated by a voltage controlled oscillator within a phase locked loop. A modulated signal may be generated via a direct digital frequency synthesizer based on the modified clock signal. The modulated signal may be upconverted to a radio frequency (RF) signal utilizing a phase locked loop and the RF signal may be amplitude modulated. The phase locked loop may be enabled to filter the RF signal.

### CROSS-REFERENCE TO RELATED APPLICATIONS/INCORPORATION BY REFERENCE

This application makes reference to:

U.S. application Ser. No. ______ (Attorney Docket No. 18195US01) filed on even date herewith;
U.S. application Ser. No. ______ (Attorney Docket No. 18200US01) filed on even date herewith;
U.S. application Ser. No. ______ (Attorney Docket No. 18201US01) filed on even date herewith;
U.S. application Ser. No. ______ (Attorney Docket No. 18202US01) filed on even date herewith;
U.S. application Ser. No. ______ (Attorney Docket No. 18204US01) filed on even date herewith; and
U.S. application Ser. No. ______ (Attorney Docket No. 18205US01) filed on even date herewith.

Each of the above stated applications is hereby incorporated by reference in its entirety.

### FIELD OF THE INVENTION

Certain embodiments of the invention relate to polar transmitters. More specifically, certain embodiments of the invention relate to a method and system for using a phase locked loop (PLL) for upconversion in a wideband crystalless polar transmitter.

### BACKGROUND OF THE INVENTION

A direct digital frequency synthesizer (DDFS) is a digitally-controlled signal generator that may vary the output signal frequency over a large range of frequencies, based on a single fixed-frequency precision reference clock. In addition, a DDFS is also phase-tunable. In essence, within the DDFS, discrete amplitude levels are input to a digital-to-analog converter (DAC) at a sampling rate determined by the fixed-frequency reference clock. The output of the DDFS may provide a signal whose shape may depend on the sequence of discrete amplitude levels that are input to the DAC at the constant sampling rate. The DDFS is particularly well suited as a frequency generator that outputs a sine or other periodic waveforms over a large range of frequencies, from almost DC to approximately half the fixed-frequency reference clock frequency.

A DDFS offers a larger range of operating frequencies and requires no feedback loop, thereby providing near instantaneous phase and frequency changes, avoiding overshooting, undershooting and settling time issues associated with other analog systems. A DDFS may provide precise digitally-controlled frequency and/or phase changes without signal discontinuities.

Polar modulation is related to inphase (I) and quadrature (Q) modulation similar to polar coordinates in the Cartesian coordinate system. For polar modulation, the orthogonal I and Q components of a RF signal may be converted to a phasor representation comprising an amplitude component and a phase component. The combined I and Q signal components may be generated with one phase change and one amplitude change, for example, whereas separate I and Q modulation may require amplitude and phase modulation for each channel, especially for non-constant envelope modulation modes. In addition, the I and Q modulation approach may require good linearity of the power amplifier, often leading to power inefficient designs that suffer from parameter variability due to factors such as temperature. In contrast, polar modulation may allow the use of very efficient and non-linear amplifier designs for non-constant envelope modulation schemes.

Both Bluetooth and WLAN radio devices, such as those used in, for example, handheld wireless terminals, generally operate in the 2.4 GHz (2.4000-2.4835 GHz) Industrial, Scientific, and Medical (ISM) unlicensed band. Other radio devices, such as those used in cordless phones, may also operate in the ISM unlicensed band. While the ISM band provides a suitable low-cost solution for many of short-range wireless applications, it may also have some drawbacks when multiple users operate simultaneously. For example, because of the limited bandwidth, spectrum sharing may be necessary to accommodate multiple users and/or multiple different types of communication protocols. Multiple active users may also result in significant interference between operating devices. Moreover, in some instances, other devices such as microwave ovens may also operate in this frequency spectrum and may produce significant interference or blocking signals that may affect Bluetooth and/or WLAN transmissions.

Oscillators may be utilized in wireless receivers and transmitters to provide frequency conversion, and to provide sinusoidal sources for modulation. The oscillators may operate over frequencies ranging from several kilohertz to many gigahertz, and may be tunable over a set frequency range. A typical oscillator may utilize a transistor with a LC network to control the frequency of oscillation. The frequency of oscillation may be tuned by adjusting the values of the LC resonator. A crystal controlled oscillator (XCO) may be enabled to provide an accurate output frequency, if the crystal is in a temperature controlled environment. A phase locked loop (PLL) may utilize a feedback control circuit and an accurate reference source such as a crystal controlled oscillator to provide an output that may be tunable with a high accuracy. Phase locked loops and other circuits that provide accurate and tunable frequency outputs may be referred to as frequency synthesizers.

Phase noise is a measure of the sharpness of the frequency domain spectrum of an oscillator, and may be critical for many modern wireless systems as it may severely degrade the performance of a wireless system. The phase noise may add to the noise level of the receiver, and a noisy local oscillator may lead to down conversion of undesired nearby signals. This may limit the selectivity of the receiver and the proximity of spacing adjacent channels in a wireless communication system.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A method and/or system for using a phase locked loop (PLL) for upconversion in a wideband crystalless polar transmitter, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 is a block diagram of an exemplary phase locked loop that may be utilized in connection with an embodiment of the invention.

FIG. 2 is a block diagram illustrating an exemplary direct digital frequency synthesizer (DDFS), in accordance with an embodiment of the invention.

FIG. 3 is a block diagram illustrating utilization of an exemplary phase locked loop for upconversion in a wideband crystalless polar transmitter, in accordance with an embodiment of the invention.

FIG. 4 is a flowchart illustrating exemplary steps illustrating utilization of an exemplary phase locked loop for upconversion in a wideband crystalless polar transmitter, in accordance with an embodiment of the invention.

### DETAILED DESCRIPTION OF THE INVENTION

Certain embodiments of the invention may be found in a method and system for using a phase locked loop (PLL) for upconversion in a wideband crystalless polar transmitter. Aspects of the method and system may comprise modifying a clock signal generated by a voltage controlled oscillator within a phase locked loop. A modulated signal may be generated via a direct digital frequency synthesizer based on the modified clock signal. The modulated signal may be upconverted to a radio frequency (RF) signal utilizing a phase locked loop and the RF signal may be amplitude modulated. The phase locked loop may be enabled to filter the RF signal.

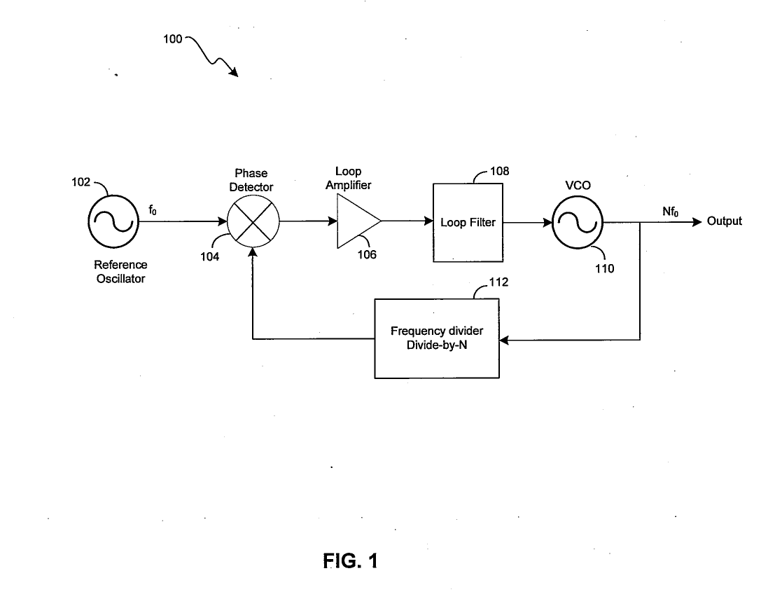

FIG. 1 is a block diagram of an exemplary phase locked loop that may be utilized in connection with an embodiment of the invention. Referring to FIG. 1, there is shown a phase locked loop (PLL) 100 that comprises a reference oscillator 102, a phase detector 104, a loop amplifier 106, a loop filter 108, a voltage controlled oscillator (VCO) 110, and a frequency divider 112.

The reference oscillator 102 may comprise suitable logic, circuitry, and/or code that may be enabled to generate a constant frequency f₀. The reference oscillator may be, for example, a crystal controlled oscillator (XCO) that may be enabled to provide an accurate output frequency. The phase detector 104 may comprise suitable logic, circuitry, and/or code that may be enabled to generate a voltage proportional to the difference in phase of the signal generated by the reference oscillator 102 and the signal generated by the frequency divider 112, and may enable modifying the frequency of the VCO 110 in order to align the phase of the VCO 110 with that of the reference oscillator 102. The loop amplifier 106 may comprise suitable logic, circuitry, and/or code that may be enabled to amplify a received signal from the phase detector 104 and generate an amplified output signal to the loop filter 108. The loop filter 108 may comprise suitable logic, circuitry, and/or code that may be enabled to filter a received signal from the loop amplifier 106 and generate a filtered output signal to the VCO 110.

The frequency divider 112 may comprise suitable logic, circuitry, and/or code that may be enabled to divide the output of the VCO 110 by N, for example, to match the frequency of the reference oscillator 102. The frequency divider circuit 112 may be programmable to synthesize a plurality of closely spaced frequencies, which enables it to be utilized in commercial wireless applications with multiple channels. The VCO 110 may comprise suitable logic, circuitry, and/or code that may be enabled to generate an output frequency that may be N times the frequency of the reference oscillator, Nf₀, for example. The PLL 100 may utilize a feedback control circuit to allow the VCO 110 to track the phase of the stable reference oscillator 102. The PLL 100 may be utilized as frequency modulation (FM) demodulators, or carrier recovery circuits, or as frequency synthesizers for modulation and demodulation. The output of the PLL 100 may have a phase noise characteristic similar to that of the reference oscillator 102, but may operate at a higher frequency. The capture range of the PLL 100 may be defined as the range of input frequency for which the loop may acquire locking. The lock range of the PLL 100 may be defined as the input frequency range over which the loop may remain locked and may be larger than the capture range. The settling time of the PLL 100 may be defined as the time required for the loop to lock on to a new frequency.

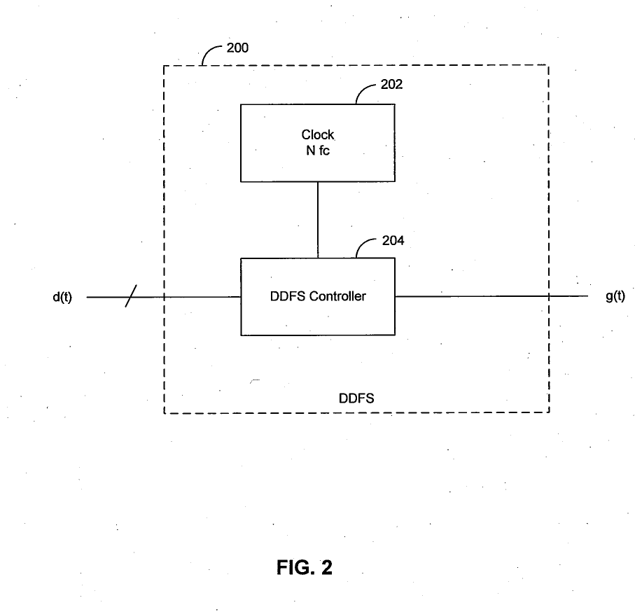

FIG. 2 is a block diagram illustrating an exemplary direct digital frequency synthesizer (DDFS), in accordance with an embodiment of the invention. Referring to FIG. 2, there is shown a DDFS 200, a clock 202 and a DDFS controller 204. The DDFS 200 may be a digitally-controlled signal generator that may vary the analog output signal g(t) over a large range of frequencies, based on a single fixed-frequency precision reference clock, for example, clock 202. Notwithstanding, the DDFS 200 may also be phase-tunable. The digital input signal d(t) may comprise control information regarding the frequency and/or phase of the analog output signal g(t) that may be generated as a function of the digital input signal d(t). The clock 202 may provide a reference clock that may be N times higher than the frequency fc of the generated output signal g(t). The DDFS controller 204 may generate a variable frequency analog output signal g(t) by utilizing the clock 202 and the digital input signal d(t).

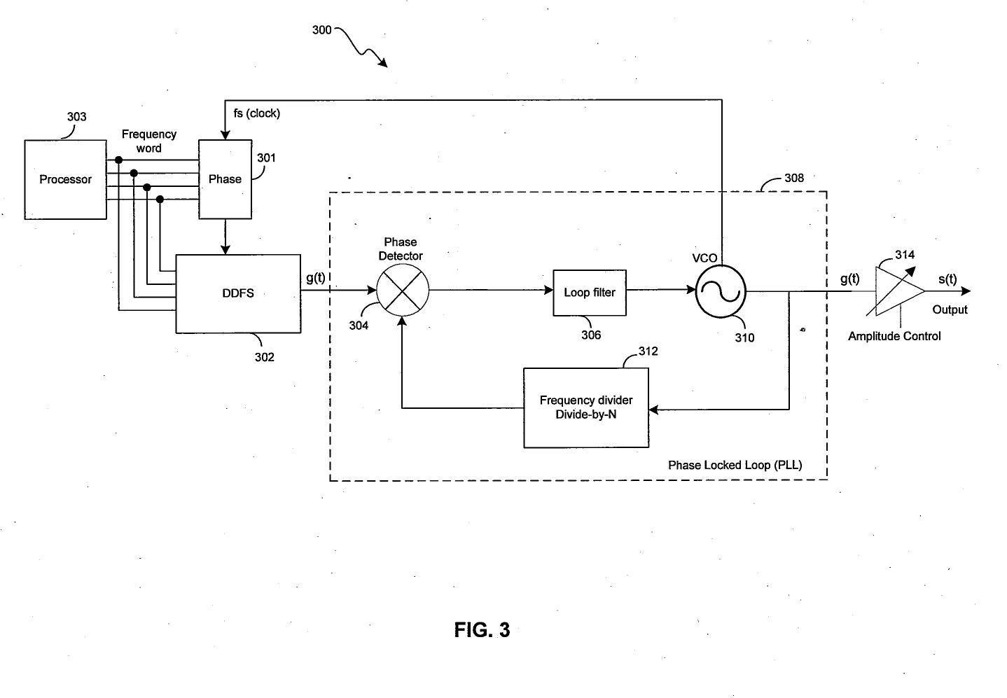

FIG. 3 is a block diagram illustrating utilization of an exemplary phase locked loop for upconversion in a wideband crystalless polar transmitter, in accordance with an embodiment of the invention. Referring to FIG. 3, there is shown a wideband polar crystalless transmitter 300. The wideband polar crystalless transmitter 300 may comprise a phase adjustment block 301, a DDFS 302, a processor 303, a phase locked loop (PLL) 308, and a power amplifier 314. The PLL 308 may comprise a phase detector 104, a loop filter 306, a voltage controlled oscillator (VCO) 310, and a frequency divider 312.

The DDFS 302 may comprise suitable logic, circuitry, and/or code that may be enabled to achieve near instantaneous frequency and phase shifts over a large frequency range while maintaining a phase-continuous signal. The DDFS 302 may be enabled to generate a plurality of modulated intermediate frequency (IF) signals. The DDFS 302 may be enabled to perform frequency and phase modulation. The DDFS 302 may be enabled to generate an analog output signal g(t), where

g(t)=cos(2πf_{C}(t)+θ(t))

where f_{C}(t)=c(t)f may be a time-varying carrier. The frequency f_{c}(t) may be time varying, for example, because of frequency hopping, and the frequency hopping sequence may be controlled by the frequency control signal c(t). The frequency f may be a constant frequency. The DDFS 302 may be crystalless and may not comprise a clock. In accordance with an embodiment of the invention, the DDFS 302 may be enabled to receive a clock signal from the VCO 310 within the PLL 308.

The phase detector 304 may comprise suitable logic, circuitry, and/or code that may be enabled to generate a voltage proportional to the difference in phase of the signal generated by the DDFS 302 and the signal generated by the frequency divider 312, and may enable modifying the frequency of the VCO 310 in order to align the phase of the VCO 310 with that of the DDFS 302. The loop filter 306 may comprise suitable logic, circuitry, and/or code that may be enabled to filter a received signal from the phase detector 304 and generate a filtered output signal to the VCO 310. For example, the loop filter 306 may be enabled to filter the RF signal, for example, by allowing signals having a frequency of 2.45 GHZ. The loop filter 306 may be enabled to select a particular frequency of the RF signal, for example, having a frequency of 2.45 GHz.

The frequency divider 312 may comprise suitable logic, circuitry, and/or code that may be enabled to divide the output of the VCO 310 by N, for example, to match the frequency of the DDFS 302. The frequency divider circuit 312 may be programmable to synthesize a plurality of closely spaced frequencies, which enables it to be utilized in a plurality of wireless applications with multiple channels. The VCO 310 may comprise suitable logic, circuitry, and/or code that may be enabled to generate an output frequency that may be N times the frequency of the DDFS 302, Nf₀, for example, where f₀ is the output frequency of DDFS 302. The PLL 308 may utilize a feedback control circuit to allow the VCO 310 to track the phase of the DDFS 302. The PLL 308 may be utilized as frequency modulation (FM) demodulators, or carrier recovery circuits, or as frequency synthesizers for modulation and demodulation. The output of the PLL 308 may have a phase noise characteristic similar to that of the DDFS 302, but may operate at a higher frequency.

The phase adjustment block 301 may comprise suitable logic, circuitry, and/or code that may be enabled to receive a clock signal fₛ from the VCO 310. The phase adjustment block 301 may be enabled to receive a frequency word comprising a plurality of bits from the processor 303. The frequency word may comprise information regarding the particular frequency channel to be selected by the DDFS 302. The DDFS 302 may be enabled to receive the frequency word comprising a plurality of bits from the processor 303. The phase adjustment block 301 may be enabled to adjust a phase of the received clock signal fₛ from the VCO 310. The phase adjustment block 301 may be enabled to generate a signal to the DDFS 302 to compensate for a change in phase of the received clock signal fₛ from the VCO 310. The phase adjustment block 301 may be enabled to modify one or more bits of the received frequency word in order to compensate for the change in phase of the received clock signal fₛ from the VCO 310.

In accordance with an embodiment of the invention, the PLL 308 may be utilized as a filter within the wideband crystalless polar transmitter 300. The PLL 308 may be enabled to filter the received signal from the DDFS 302. The PLL 308 may be enabled to upconvert the received signal from the DDFS 302. For example, the DDFS 308 may be enabled to generate an intermediate frequency (IF) signal to the PLL 308. The PLL 308 may be enabled to upconvert the received IF signal to a radio frequency (RF) signal and communicate the generated RF signal to the power amplifier 314.

The power amplifier 314 may comprise suitable logic, circuitry, and/or code that may be enabled to amplitude modulate the received RF signal from the PLL 308. The power amplifier 314 may be enabled to perform amplitude modulation. The power amplifier 314 may be controlled by an amplitude control signal to enable amplitude modulation of the received RF signal. The power amplifier 314 may amplitude modulate the RF signal g(t) to generate the transmit signal s(t), where

s(t)=a(t)g(t)

The signal s(t) may then be transmitted via an antenna.

The DDFS 302 may be enabled to generate the modulated IF signal, for example, g(t). The DDFS 302 may be enabled to select a particular frequency channel of the generated modulated IF signal. For example, the DDFS 302 may be enabled to generate a modulated IF signal in the frequency range of 20-30 MHz, for example. The PLL 308 may be enabled to upconvert the modulated IF signal to a RF signal, for example, in the frequency range of 2.4-2.8 GHz. The PLL 308 may be enabled to filter the RF signal, for example, by allowing signals having a frequency of 2.45 GHz. The PLL 308 may be enabled to select a particular frequency of the RF signal, for example, having a frequency of 2.45 GHz. The power amplifier 314 may be enabled to amplitude modulate the generated modulated IF signal.

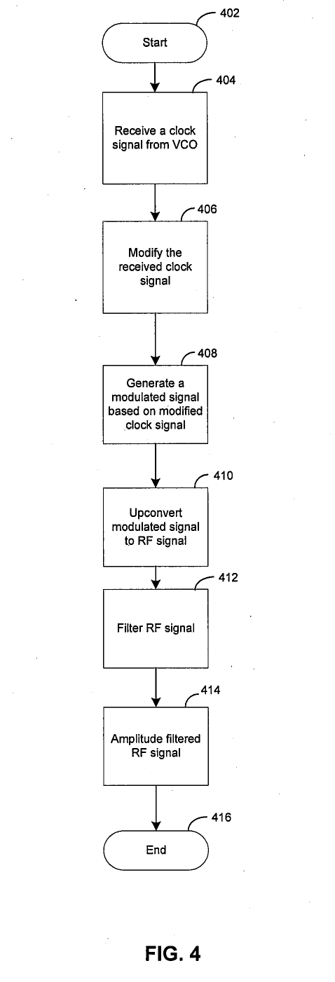

FIG. 4 is a flowchart illustrating exemplary steps illustrating utilization of an exemplary phase locked loop for upconversion in a wideband crystalless polar transmitter, in accordance with an embodiment of the invention.

Referring to FIG. 4, exemplary steps may begin at step 402. In step 404, the phase adjustment block 301 may be enabled to receive a clock signal fₛ from the VCO 310. In step 406, the wideband polar crystalless transmitter 300 may be enabled to modify the received clock signal fₛ by adjusting a phase of the received clock signal fₛ. In step 408, a modulated signal may be generated via DDFS 302 based on the modified clock signal. In step 410, the modulated signal may be upconverted to a radio frequency (RF) signal utilizing PLL 308. In step 412, the RF signal may be filtered. In step 414, the filtered RF signal may be amplitude modulated. Control then passes to end step 416.

In accordance with an embodiment of the invention, a method and system for using a phase locked loop (PLL) for upconversion in a wideband crystalless polar transmitter may include a phase adjustment block 301 that may be enabled to receive a clock signal fₛ from the VCO 310. The wideband polar crystalless transmitter 300 may be enabled to modify the received clock signal fₛ by adjusting a phase of the received clock signal fₛ. The DDFS 302 may be enabled to generate a modulated signal, for example, g(t) based on the modified clock signal. The PLL 308 may be enabled to upconvert the modulated signal to a radio frequency (RF) signal. The PLL 308 may be enabled to filter the RF signal. The power amplifier 314 may be enabled to amplitude modulate the filtered RF signal.

The DDFS 302 may be enabled to phase modulate the modulated signal. The DDFS 302 may be enabled to frequency modulate the modulated signal. The DDFS 302 may be enabled to select a particular frequency channel of the modulated IF signal. For example, the DDFS 302 may be enabled to generate a modulated IF signal in the frequency range of 20-30 MHz, for example. The PLL 308 may be enabled to upconvert the modulated IF signal to a RF signal, for example, in the frequency range of 2.4-2.8 GHz. The PLL 308 may be enabled to filter the RF signal, for example, by allowing signals having a frequency of 2.45 GHz. The PLL 308 may be enabled to select a particular frequency of the RF signal, for example, having a frequency of 2.45 GHz. The power amplifier 314 may be enabled to amplitude modulate the generated modulated IF signal.

Another embodiment of the invention may provide a machine-readable storage, having stored thereon, a computer program having at least one code section executable by a machine, thereby causing the machine to perform the steps as described above for using a phase locked loop (PLL) for upconversion in a wideband crystalless polar transmitter.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing communication signals in a transmitter, the method comprising:
modifying a clock signal generated by a voltage controlled oscillator within a phase locked loop; and
generating a modulated signal via a direct digital frequency synthesizer based on said modified clock signal.

2. The method according to claim 1, comprising upconverting said modulated signal to a radio frequency (RF) signal utilizing said phase locked loop.

3. The method according to claim 2, comprising filtering said RF signal utilizing said phase locked loop.

4. The method according to claim 3, comprising amplitude modulating said filtered RF signal.

5. The method according to claim 1, comprising modifying said clock signal by adjusting a phase of said clock signal.

6. The method according to claim 1, comprising selecting a particular frequency channel utilizing said direct digital frequency synthesizer.

7. The method according to claim 1, comprising phase modulating said modulated via said direct digital frequency synthesizer.

8. The method according to claim 1, comprising frequency modulating said modulated signal via said direct digital frequency synthesizer.

9. The method according to claim 1, comprising selecting a particular frequency of said RF signal utilizing said phase locked loop.

10. A system for processing communication signals in a transmitter, the system comprising:
one or more circuits comprising at least a direct digital frequency synthesizer and a phase locked loop having a voltage controlled oscillator, said one or more circuits enables modification of a clock signal generated by said voltage controlled oscillator; and
said one or more circuits enables generation of a modulated signal via said direct digital frequency synthesizer based on said modified clock signal.

11. The system according to claim 10, wherein said one or more circuits enables upconversion of said modulated signal to a radio frequency (RF) signal utilizing said phase locked loop.

12. The system according to claim 11, wherein said one or more circuits enables filtering of said RF signal utilizing said phase locked loop.

13. The system according to claim 12, wherein said one or more circuits enables amplitude modulation of said filtered RF signal.

14. The system according to claim 10, wherein said one or more circuits enables modification of said clock signal by adjusting a phase of said clock signal.

15. The system according to claim 10, wherein said one or more circuits enables selection of a particular frequency channel utilizing said direct digital frequency synthesizer.

16. The system according to claim 10, wherein said one or more circuits enables phase modulation of said modulated signal via said direct digital frequency synthesizer.

17. The system according to claim 10, wherein said one or more circuits enables frequency modulation of said modulated signal via said direct digital frequency synthesizer.

18. The system according to claim 10, wherein said one or more circuits enables selection of a particular frequency of said RF signal utilizing said phase locked loop.

19. A machine-readable storage having stored thereon, a computer program having at least one code section for processing communication signals in a transmitter, the at least one code section being executable by a machine for causing the machine to perform steps comprising:
modifying a clock signal generated by a voltage controlled oscillator within a phase locked loop; and
generating a modulated signal via a direct digital frequency synthesizer based on said modified clock signal.

20. The machine-readable storage according to claim. 19, wherein said at least one code section comprises code for upconverting said modulated signal to a radio frequency (RF) signal utilizing said phase locked loop.

21. The machine-readable storage according to claim 20, wherein said at least one code section comprises code for filtering said RF signal utilizing said phase locked loop.

22. The machine-readable storage according to claim 21, wherein said at least one code section comprises code for amplitude modulating said filtered RF signal.

23. The machine-readable storage according to claim 19, wherein said at least one code section comprises code for modifying said clock signal by adjusting a phase of said clock signal.

24. The machine-readable storage according to claim 19, wherein said at least one code section comprises code for selecting a particular frequency channel utilizing said direct digital frequency synthesizer.

25. The machine-readable storage according to claim 19, wherein said at least one code section comprises code for phase modulating said modulated signal via said direct digital frequency synthesizer.

26. The machine-readable storage according to claim 19, wherein said at least one code section comprises code for frequency modulating said modulated signal via said direct digital frequency synthesizer.

27. The machine-readable storage according to claim 19, wherein said at least one code section comprises code for selecting a particular frequency of said RF signal utilizing said phase locked loop.
